(19) United States
(12) Patent Application Publication
(10) Pub. No.: US 2026/0097575 A1
(43) Pub. Date: Apr. 9, 2026

(54) COLORED LAMINATE FOR RADIATIVE COOLING AND RADIATIVE COOLING MATERIAL INCLUDING THE SAME

(71) Applicants: Hyundai Motor Company, Seoul (KR); Kia Corporation, Seoul (KR)

(72) Inventor: Min Jae Lee, Hwaseong-si (KR)

(21) Appl. No.: 18/905,568

(22) Filed: Oct. 3, 2024

(30) Foreign Application Priority Data
Dec. 8, 2023 (KR) 10-2023-0178068

(51) Int. Cl. B32B 7/027; B32B 15/09; B32B 27/08; B32B 27/30; B32B 27/32; B32B 27/36

(52) U.S. Cl. CPC B32B 7/027; B32B 15/09; B32B 27/08; B32B 27/308; B32B 27/32; B32B 27/36; B32B 2250/04; B32B 2307/30; B32B 2307/402; B32B 2307/7376

(57) ABSTRACT

An embodiment colored laminate for radiative cooling includes a near-infrared-ray reflecting layer including a metal, a long-wavelength infrared-ray radiating layer disposed on the near-infrared-ray reflecting layer and including a first thermoplastic resin, a visible light reflecting layer disposed on the long-wavelength infrared-ray radiating layer and including a second thermoplastic resin, and a colored layer disposed on the visible light reflecting layer and including a third thermoplastic resin.

### CROSS-REFERENCE TO RELATED APPLICATIONS

This application claims the benefit of Korean Patent Application No. 10-2023-0178068, filed on Dec. 8, 2023, which application is hereby incorporated herein by reference.

### TECHNICAL FIELD

The present disclosure relates to a colored laminate for radiative cooling and a radiative cooling material including the same.

### BACKGROUND

In general, energy consumption is essential for cooling. For example, a general-purpose cooling apparatus, such as a refrigerator and an air conditioner, uses energy to compress refrigerant and then performs the cooling using absorption of heat generated when the compressed refrigerant expands. Unlike the general-purpose cooling apparatus, radiative cooling is a technology that may perform the cooling without wasting the energy. To improve a radiative cooling efficiency, it is important to well control the absorption, reflection, and radiation of light in each wavelength band. Most heat is generated from incident sunlight. The sunlight is divided into ultraviolet (UV) light, visible light, and infrared light. When reflecting light in each wavelength band, inflow of the heat via the sunlight may be blocked. For example, an internal temperature of a black vehicle that absorbs light well during a sunny day increases easily, but an internal temperature of a white vehicle that reflects light well rather than absorbs the same increases relatively slowly.

A variety of materials, such as a polymer, a multi-layer thin film made of an inorganic material or a ceramic material, a component for the radiative cooling including a metal reflective layer, and a paint containing a white pigment, are used as a material for the radiative cooling. The polymer material generally has a high absorptivity (an emissivity) for the infrared light, but it is easily deteriorated by ultraviolet light, moisture, and the like when left outdoors because of a nature thereof and thus has a short lifespan. In the case of the multi-layer thin film, the number of layers must be increased to increase the emissivity for the infrared light, which increases an absorptivity of the sunlight, making it difficult to achieve a high-efficiency radiative cooling performance. In addition, the material including the metal reflective layer is difficult to be applied in real life because of low long-term stability caused by oxidation of metal and a unit cost issue. Because such metal material performs regular reflection, eye fatigue and light blur are caused. The paint containing the white pigment is generally not composed of a material with a high extinction coefficient, and thus it has an insufficient radiative cooling ability because of insufficient infrared emissivity and ultraviolet reflectance.

As an alternative to this problem, Korean Patent No. 2225793, published on Mar. 11, 2021, (Patent Document 1) discloses a colored radiative cooling device including a solar light reflecting layer made of a metal material to reflect sunlight, a scattering layer made of a mixture of a polymer that absorbs and radiates infrared rays and scattering nanoparticles that scatter the sunlight, and a colored layer made of colored nanoparticles coated with infrared-ray radiating nanoparticles and rendering a color corresponding to a type of the colored nanoparticles. However, since the radiative cooling device of Patent Document 1 uses the colored nanoparticles, it may be difficult to achieve a desired color, and a problem may occur in which a temperature of the radiative cooling device increases due to the colored nanoparticles.

Therefore, there is a need for research and development on a material that has excellent UV-ray and near-infrared-ray reflectance and long-wavelength infrared-ray radiation, thereby providing an excellent radiative cooling effect.

### SUMMARY

The present disclosure relates to a colored laminate for radiative cooling and a radiative cooling material including the same. Particular embodiments relate to a colored laminate for radiative cooling which has excellent visible light and near-infrared-ray reflectance, excellent long-wavelength infrared-ray radiation, and thus excellent radiative cooling effect, and a radiative cooling material including the same.

Embodiments of the present disclosure can solve problems occurring in the prior art while advantages achieved by the prior art are maintained intact.

An embodiment of the present disclosure provides a colored laminate for radiative cooling that has excellent UV-ray and near-infrared-ray reflectance and long-wavelength infrared-ray radiation, which thus has an excellent radiative cooling effect, and a radiative cooling material including the same.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a colored laminate for radiative cooling includes a near-infrared-ray reflecting layer including a metal, a long-wavelength infrared-ray radiating layer formed on the near-infrared-ray reflecting layer and including a first thermoplastic resin, a visible light reflecting layer formed on the long-wavelength infrared-ray radiating layer and including a second thermoplastic resin, and a colored layer formed on the visible light reflecting layer and including a third thermoplastic resin.

Furthermore, embodiments of the present disclosure provide a radiative cooling material including the colored laminate for radiative cooling.

Moreover, embodiments of the present disclosure provide a mobility including the radiative cooling material.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a cross-sectional view of a colored laminate for radiative cooling according to an embodiment of the present disclosure;

FIGS. 2 and 5 show results of measuring a reflectance of a laminate according to an example embodiment of the present disclosure;

FIG. 3 shows a result of measuring an infrared-ray emissivity of a laminate according to an example embodiment of the present disclosure; and

FIG. 4 shows an infrared-ray emissivity measurement result of a laminate of a comparative example.

### DETAILED DESCRIPTION OF ILLUSTRATIVE EMBODIMENTS

Herein, when one component “includes” a certain component, this means that the one component may further include other components rather than excluding other components, unless specifically stated otherwise.

Herein, when one member is described to be located on a “surface”, “top”, “one surface”, “other surface”, or “both surfaces” of another member, this refers not only to a case in which the one member is in contact with said another member, but also to a case in which a third member exists between the two members.

In addition, herein, “a weight average molecular weight” may be measured by a method well known in the art, and it may represent, for example, a value measured by a gel permeation chromatograph (GPC) method.

### Colored Laminate for Radiative Cooling

The colored laminate for radiative cooling according to embodiments of the present disclosure includes a near-infrared-ray reflecting layer, a long-wavelength infrared-ray radiating layer formed on the near-infrared-ray reflecting layer, a visible light reflecting layer formed on the long-wavelength infrared-ray radiating layer, and a colored layer formed on the visible light reflecting layer.

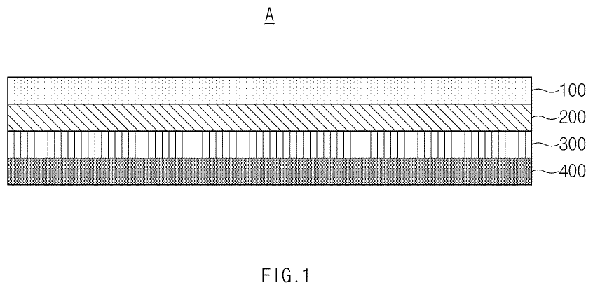

Referring to FIG. 1, the colored laminate A for radiative cooling according to embodiments of the present disclosure includes a stack of a near-infrared-ray reflecting layer 400, a long-wavelength infrared-ray radiating layer 300, a visible light reflecting layer 200, and a colored layer 100 in this order.

Moreover, the colored layer includes a third thermoplastic resin, the visible light reflecting layer includes a second thermoplastic resin, and the long-wavelength infrared-ray radiating layer includes a first thermoplastic resin. In this regard, the first thermoplastic resin, the second thermoplastic resin, and the third thermoplastic resin may have different optical properties, specifically, refractive indexes and/or extinction coefficients, from each other. Accordingly, wavelengths of light which may be radiated and/or reflected from the colored layer, the visible light reflecting layer, and the long-wavelength infrared-ray radiating layer, respectively, may be different from each other. As described above, the laminate for radiative cooling according to embodiments of the present disclosure which includes the three layers respectively including the three types of thermoplastic resins with different optical properties has very excellent radiative cooling ability.

### Near-Infrared-Ray Reflecting Layer

The near-infrared-ray reflecting layer serves to block heat by selectively reflecting near-infrared-rays with a wavelength of 0.75 to 2.0 μm.

The near-infrared-ray reflecting layer includes a metal. For example, the near-infrared-ray reflecting layer may include at least one single metal selected from the group consisting of aluminum (Al), silver (Ag), gold (Au), chromium (Cr), copper (Cu), platinum (Pt), iron (Fe), tin (Sn), nickel (Ni), and alloys thereof. Specifically, the near-infrared-ray reflecting layer may include Al, Ag, Au, or Cr. When the near-infrared-ray reflecting layer includes one or more of the metals as described above, the near-infrared-ray reflectance of the laminate increases due to light interference.

Moreover, the near-infrared-ray reflecting layer may have an average thickness of 1 to 150 nm, 20 to 150 nm, or 30 to 100 nm. When the average thickness of the near-infrared-ray reflecting layer is below the above range, the near-infrared-ray reflection effect is reduced, such that the radiative cooling performance of the laminate may be insufficient. When the thickness exceeds the above range, the reflection effect thereof at unwanted wavelengths increases, which may cause the laminate to display colors other than a target color or cause the laminate's radiative cooling performance to be insufficient.

### Long-Wavelength Infrared-Ray Radiating Layer

The long-wavelength infrared-ray radiating layer may radiate a long-wavelength infrared-ray with a wavelength of 8 to 13 μm. Thus, the long-wavelength infrared-ray radiating layer serves to improve the radiative cooling performance of the laminate by dissipating heat within the laminate containing the same to the outside.

The long-wavelength infrared-ray radiating layer is formed on the near-infrared-ray reflecting layer and includes the first thermoplastic resin.

The first thermoplastic resin may include one or more types selected from the group consisting of, for example, polyester, acrylic resin, polyolefin, polyurethane, polystyrene (PS), cellulose-based resin, silicone, and copolymers thereof.

In an example, the first thermoplastic resin may include one or more types selected from the group consisting of, for example, polyethylene terephthalate (PET), polybutylene terephthalate (PBT), acrylonitrile-butadiene-styrene (ABS), polypropylene (PP), poly(methyl methacrylate) (PMMA), polymethylpentene (PMP), ethylene tetrafluoroethylene (ETFE), polydimethylsiloxane (PDMS), polylactic acid (PLA) and copolymers thereof.

Specifically, the first thermoplastic resin may include polyester. More specifically, the polyester may include one or more types selected from the group consisting of polyethylene terephthalate (PET), polybutylene terephthalate (PBT), and copolymers thereof.

Moreover, the first thermoplastic resin may have a weight average molecular weight (Mw) of 1,000 to 500,000 g/mol, 2,000 to 300,000 g/mol, or 5,000 to 100,000 g/mol. When the weight average molecular weight of the first thermoplastic resin is outside the above range, the selective emissivity of the long-wavelength infrared-ray decreases, and the radiative cooling ability of the laminate may decrease.

The first thermoplastic resin may have an emissivity of 75 to 95% or 80 to 90% at a wavelength of 8 to 13 μm. That is, the first thermoplastic resin has excellent emissivity at a wavelength of 8 to 13 μm and may selectively radiate a portion of the long-wavelength infrared-ray. When the emissivity of the first thermoplastic resin is outside the above range, the heat inside the laminate is not effectively dissipated to the outside, which may cause the temperature of the laminate to increase.

The long-wavelength infrared-ray radiating layer may have an average thickness of 10 to 300 μm, 60 to 150 μm, or 80 to 130 μm. When the average thickness of the long-wavelength infrared-ray radiating layer is below and/or above the above range, the long-wavelength infrared-ray selective emissivity may be reduced, which may result in a decrease in the radiative cooling ability of the laminate.

### Visible Light Reflecting Layer

The visible light reflecting layer serves to block heat by reflecting the visible light and UV-rays with a wavelength of 30 to 780 nm.

The visible light reflecting layer is formed on the long-wavelength infrared-ray radiating layer and includes the second thermoplastic resin.

The second thermoplastic resin may include, for example, polyolefin. The polyolefin may include, for example, one or more selected from the group consisting of polyethylene (PE), polypropylene (PP), polybutylene (PB), and copolymers thereof. Specifically, the polyolefin may include polyethylene (PE).

The visible light reflecting layer is not particularly limited in terms of a form as long as it includes the second thermoplastic resin and is generally usable in manufacturing the laminate. For example, the visible light reflecting layer may be in a form of a textile, a film, a sheet, etc.

Moreover, the visible light reflecting layer may have an average thickness of 100 to 300 μm, 130 to 250 μm, or 130 to 200 μm. When the average thickness of the visible light reflecting layer is smaller than the above range, the radiative cooling performance may deteriorate as the UV-ray and/or visible light reflectance of the laminate decreases. When the thickness exceeds the above range, problems may arise where the flexibility of the laminate is reduced.

### Colored Layer

The colored layer is responsible for imparting color to the laminate.

The colored layer is formed on the visible light reflecting layer and includes the third thermoplastic resin. Specifically, the colored layer may include the third thermoplastic resin and have a color.

The third thermoplastic resin may include, for example, an acrylic resin.

In this regard, the acrylic resin may include one or more selected from the group consisting of poly(methyl methacrylate) (PMMA), poly(methyl acrylate) (PMA), and copolymers thereof. For example, the acrylic resin may include one or more selected from the group consisting of poly(methyl methacrylate) and poly(methyl acrylate). Specifically, the acrylic resin may include poly(methyl methacrylate) (PMMA).

The third thermoplastic resin may have a transmittance of 80% to 95% at a wavelength of 250 to 2,500 nm. Moreover, the third thermoplastic resin may have a reflectance of 3% to 15% or 5% to 10% at a wavelength of 250 to 2,500 nm. When the transmittance and/or the reflectance of the third thermoplastic resin is outside the above range, this may affect the optical properties of the laminate or increase or decrease the transmittance and/or reflectance at wavelengths other than a target wavelength, thereby causing the laminate to render a different color from a target color.

The colored layer may be colored with a chromatic color.

Moreover, the colored layer may have an average thickness of 10 to 200 μm, 30 to 150 μm, or 50 to 100 μm. When the average thickness of the colored layer is smaller than the above range, problems may arise where the color rendered by the manufactured laminate is deviated from the target color. When the thickness exceeds the above range, the effect that may be achieved compared to the thickness of the colored layer may be lower, which may lead to problems of low economic feasibility.

The colored layer may have a transmittance of 80% or greater or 80 to 95% for light with a wavelength of 400 to 780 nm. When the transmittance of the colored layer for the light with a wavelength of 400 to 780 nm is smaller than the above range, problems may arise where durability is reduced due to UV-rays. When the transmittance of the colored layer for the light with a wavelength of 400 to 780 nm exceeds the above range, the cooling performance of the manufactured laminate may deteriorate due to infrared-ray transmission.

The colored laminate for radiative cooling may have an average reflectance of 80% or greater or 85 to 98% for the light with a wavelength of 300 to 800 nm.

Moreover, the colored laminate for radiative cooling may have an average emissivity of 50 to 98% or 80 to 98% for the long-wavelength infrared-ray with a wavelength of 8 to 15 μm.

The colored laminate for radiative cooling according to embodiments of the present disclosure as described above has excellent UV-ray and near-infrared-ray reflectance and long-wavelength infrared-ray radiation, and thus the radiative cooling effect thereof is very excellent. Moreover, the colored laminate for radiative cooling has excellent emissivity at a wavelength of 8 to 14 μm, which is the atmospheric window, and thus has excellent radiative cooling ability. Furthermore, the colored laminate for radiative cooling has excellent durability against sunlight and may be suitably used as an outdoor material exposed to sunlight for a long time, such as in a mobility and buildings.

### Radiative Cooling Material

The radiative cooling material in accordance with embodiments of the present disclosure includes the colored laminate for radiative cooling as described above.

For example, the radiative cooling material may be applied to a material for a mobility or building exterior. In this regard, the mobility may include, for example, cars, aircraft, trains, ships, or various mobile robots. Moreover, the building may be movable or fixed.

When the radiative cooling material is applied to the exterior of the mobility or the building, the near-infrared-ray reflecting layer of the radiative cooling material may be deposited on the mobility or the building. That is, the mobility or the building, the near-infrared-ray reflecting layer, the long-wavelength infrared-ray radiating layer, the visible light reflecting layer, and the colored layer may be stacked in that order. Thus, the radiative cooling effect may be further improved by the laminate absorbing the heat from the mobility or building under the near-infrared-ray reflecting layer and discharging the heat to the outside through the colored layer.

As described above, the radiative cooling material according to embodiments of the present disclosure has excellent UV-ray and near-infrared-ray reflectance and long-wavelength infrared-ray radiation, and thus the radiative cooling effect thereof is very excellent. Moreover, the radiative cooling material may be suitably used as an outdoor material exposed to sunlight for a long time, such as in the mobility and the building that require excellent radiative cooling ability and excellent durability against sunlight.

### Mobility or Building

The mobility or the building according to embodiments of the present disclosure includes the above radiative cooling material. Thus, the mobility and/or the building is capable of saving cooling energy during summer or when exposed to strong sunlight, thereby providing excellent energy efficiency.

In this regard, the mobility may include, for example, cars, aircraft, trains, ships, or various mobile robots. Moreover, the building may be movable or fixed.

Hereinafter, embodiments of the present disclosure are described in more detail through examples. However, these examples are only intended to help understand embodiments of the present disclosure, and the scope of the present disclosure is not limited to these examples in any way.

### EXAMPLES

### Present Example 1. Manufacturing of Laminate

Low-density polyethylene (LDPE) textile (manufacturing company: DuPont, product name: Tyvek, average thickness: 150 μm) was used as the visible light reflecting layer. Afterwards, a PET film (manufacturing company: Toray, product name: pet film, average thickness 100 μm) made of polyethylene terephthalate (PET, Mw: 18,000 g/mol) was stacked on the LDPE textile to form the long-wavelength infrared-ray radiating layer. Afterwards, a silver (Ag) thin film (average thickness 50 nm) was stacked, as the near-infrared-ray reflecting layer, on the long-wavelength infrared-ray radiating layer.

Afterwards, a red PMMA film (manufacturing company: LXMMA, product name: PMMA sheet, average thickness 100 μm) made of poly(methyl methacrylate) (PMMA, Mw: 52,000 g/mol) was stacked on the visible light reflecting layer to form the colored layer. In this way, the laminate was manufactured.

### Present Examples 2 to 9 and Comparative Examples 1 to 4

The laminates were manufactured in the same manner as in Present Example 1, except that a thickness and a composition of each of the layers were adjusted as shown in Table 1.

TABLE 1

| | Thickness of | Thickness of | Thickness of | |
|---|---|---|---|---|
| | near-infrared-ray | long-wavelength | visible light | Thickness of |
| | reflecting layer | infrared-ray | reflecting layer | colored layer |
| | (Ag thin film) | radiating layer | (LDPE textile) | (PMMA film) |
| | (nm) | (PET film) (μm) | (μm) | (μm) |
| Present | 50 | 100 | 150 | 100 |
| Example 1 | | | | |
| Present | 10 | 100 | 150 | 100 |
| Example 2 | | | | |
| Present | 100 | 100 | 150 | 100 |
| Example 3 | | | | |
| Present | 50 | 50 | 150 | 100 |
| Example 4 | | | | |
| Present | 50 | 200 | 150 | 100 |
| Example 5 | | | | |
| Present | 50 | 100 | 50 | 100 |
| Example 6 | | | | |
| Present | 50 | 100 | 300 | 100 |
| Example 7 | | | | |
| Present | 50 | 100 | 150 | 50 |
| Example 8 | | | | |
| Present | 50 | 100 | 150 | 500 |
| Example 9 | | | | |
| Compar- | 50 | 100 | 150 | — |
| ative | | | | |
| Example 1 | | | | |
| Compar- | 50 | 100 | — | 100 |
| ative | | | | |
| Example 2 | | | | |
| Compar- | 50 | — | 150 | 100 |
| ative | | | | |
| Example 3 | | | | |
| Compar- | — | 100 | 150 | 100 |
| ative | | | | |
| Example 4 | | | | |

### Comparative Example 5

The laminate was manufactured in the same manner as in Present Example 1 except that the near-infrared-ray radiating layer (Ag thin film), the visible light reflecting layer (LDPE textile), the colored layer (PMMA film), and the long-wavelength infrared-ray radiating layer (PET film) were stacked in this order.

### Comparative Example 6

The laminate was manufactured in the same manner as in Present Example 1 except that the long-wavelength infrared-ray radiating layer (PET film), the visible light reflecting layer (LDPE textile), the colored layer (PMMA film), and the near-infrared-ray radiating layer (Ag thin film) were stacked in this order.

### Test Example 1: Evaluation of Optical Properties

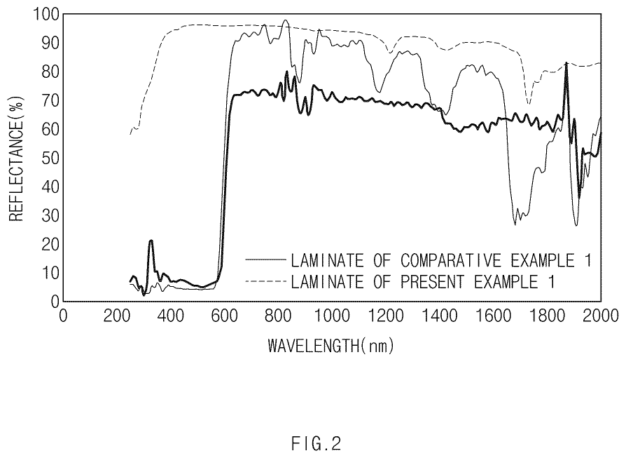

The optical properties of the laminates of the present examples and the comparative examples were evaluated in a following manner. The results are shown in Table 2 and FIGS. 2 to 4.

Specifically, an integrating sphere was mounted on a UV-ray-visible light spectrophotometer (UV-VIS spectrophotometer) and a Fourier Transform Infrared (FT-IR) spectrometer, and then the reflectance and emissivity of each of the laminates of the present examples and the comparative examples at a wavelength of 0.2 to 20 μm were measured.

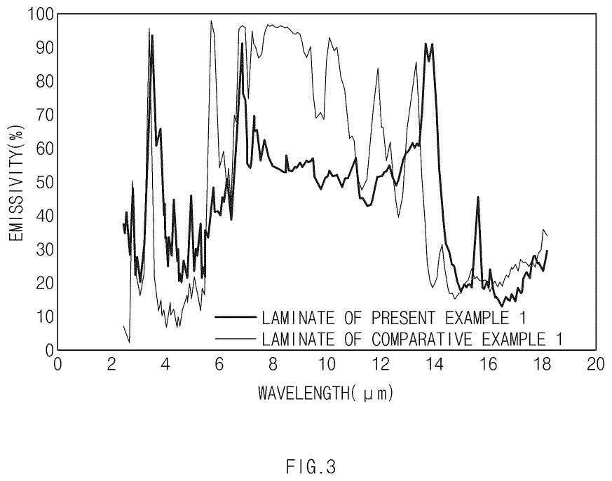

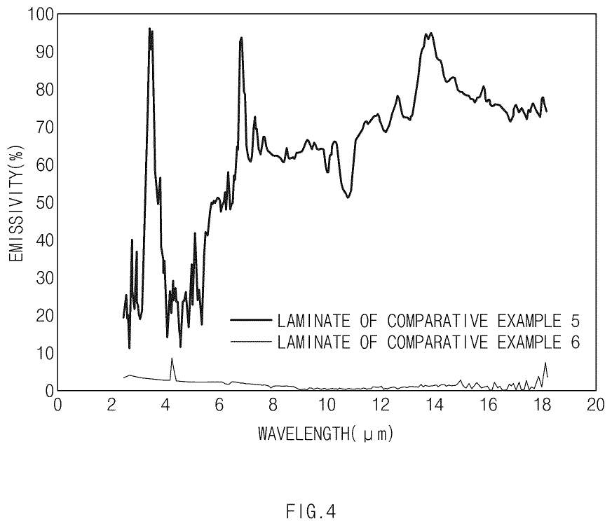

In this regard, the measurement result of the reflectance of the laminate of each of Present Example 1 and Comparative Example 1 is shown in FIG. 2, and the measurement result of the infrared-ray emissivity thereof is shown in FIG. 3. Moreover, the measurement result of the infrared-ray emissivity of the laminate of each of Comparative Examples 5 and 6 is shown in FIG. 4.

TABLE 2

| | Average | Average |
|---|---|---|
| | reflectance (%) | emissivity (%) |
| | at wavelength | at wavelength |
| | 0.38 to 2.5 μm | 2 to 20 μm |
| Present | 95 | 95 |
| Example 1 | | |
| Present | 70 | 95 |
| Example 2 | | |
| Present | 95 | 95 |
| Example 3 | | |
| Present | 95 | 80 |
| Example 4 | | |
| Present | 95 | 95 |
| Example 5 | | |
| Present | 80 | 97 |
| Example 6 | | |
| Present | 97 | 80 |
| Example 7 | | |
| Present | 90 | 80 |
| Example 8 | | |
| Present | 95 | 95 |
| Example 9 | | |
| Comparative | 90 | 90 |
| Example 1 | | |
| Comparative | 80 | 97 |
| Example 2 | | |
| Comparative | 90 | 85 |
| Example 3 | | |
| Comparative | 70 | 95 |
| Example 4 | | |
| Comparative | 97 | 10 |
| Example 5 | | |
| Comparative | 70 | 97 |
| Example 6 | | |

As shown in Table 2 and FIGS. 2 and 3, the laminate of Present Example 1 has significantly high selective emissivity at the wavelength of 8 to 14 μm, which is the atmospheric window, has significantly high broadband emissivity at the wavelength of 2 to 20 μm, and has high reflectance for light at the wavelength ranging from 0.38 μm to 2.5 μm and thus is expected to have excellent radiative cooling ability.

In particular, as shown in FIGS. 2 and 3, compared to the laminate of Comparative Example 1 which does not include the colored layer, the laminate of Present Example 1 has significantly higher selective emissivity at the wavelength of 8 to 14 μm, which is the atmospheric window, and thus it is expected that the radiative cooling ability thereof is excellent.

On the other hand, as shown in FIG. 4, each of the laminates of Comparative Examples 5 and 6 which had different stacking orders from that of embodiments of the present disclosure has low selective emissivity at the wavelength of 8 to 14 μm, which is the atmospheric window. In particular, the laminate of Comparative Example 6 in which the long-wavelength infrared-ray radiating layer (PET film), the visible light reflecting layer (LDPE textile), the colored layer (PMMA film), and the near-infrared-ray radiating layer (Ag thin film) are stacked in this order has a significantly low infrared-ray emissivity and thus is expected to have poor radiative cooling ability.

### Comparative Example 7

The laminate was manufactured in the same manner as in Present Example 1, except that a red paper (average thickness 200 μm) instead of the PMMA film was used as the colored layer.

### Present Example 10

The laminate was manufactured in the same manner as in Present Example 1, except that a red PET-PMMA film (manufacturing company: LXMMA, product name: PET-PMMA film, average thickness 200 μm) instead of the PMMA film was used as the colored layer.

### Test Example 2: Evaluation of Optical Properties

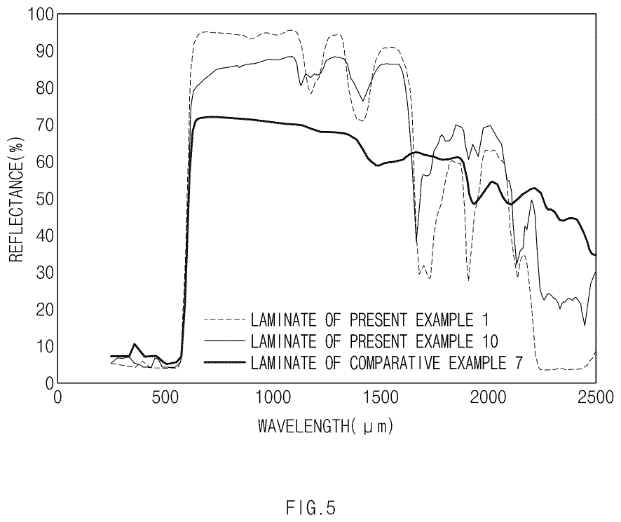

The reflectance of the laminate of each of Present Examples 1 and 10 and Comparative Example 7 was measured in the same manner as in Test Example 1. In this regard, the measurement results are shown in FIG. 5.

As shown in FIG. 5, compared to Comparative Example 7 in which the red paper is used as the colored layer, the laminates of each of Present Examples 1 and 10 in which the red polymer film is used as the colored layer has significantly greater reflectance for the light with a wavelength of 600 to 1,500 nm, and thus are expected to have excellent radiative cooling performance.

The colored laminate for radiative cooling according to embodiments of the present disclosure as described above has excellent UV-ray and near-infrared-ray reflectance and long-wavelength infrared-ray radiation, and thus the radiative cooling effect thereof is very excellent. Moreover, the colored laminate for radiative cooling has excellent emissivity at a wavelength of 8 to 14 μm, which is the atmospheric window, and thus has excellent radiative cooling ability. For this reason, the radiative cooling material including the colored laminate for radiative cooling may be suitably used as an outdoor material exposed to sunlight for a long time, such as in a mobility and buildings, which require excellent radiative cooling ability and excellent durability against sunlight.

Hereinabove, although embodiments of the present disclosure have been described with reference to exemplary embodiments and the accompanying drawings, the present disclosure is not limited thereto, but it may be variously modified and altered by those skilled in the art to which the present disclosure pertains without departing from the spirit and scope of the present disclosure claimed in the following claims.

What is claimed is:

1. A colored laminate for radiative cooling, the colored laminate comprising:
a near-infrared-ray reflecting layer comprising a metal;
a long-wavelength infrared-ray radiating layer disposed on the near-infrared-ray reflecting layer and comprising a first thermoplastic resin;
a visible light reflecting layer disposed on the long-wavelength infrared-ray radiating layer and comprising a second thermoplastic resin; and
a colored layer disposed on the visible light reflecting layer and comprising a third thermoplastic resin.

2. The colored laminate of claim 1, wherein the metal comprises at least one metal selected from the group consisting of aluminum, silver, gold, chromium, copper, platinum, iron, tin, nickel, and alloys thereof.

3. The colored laminate of claim 1, wherein:
the first thermoplastic resin comprises polyester;
the second thermoplastic resin comprises polyolefin; and
the third thermoplastic resin comprises acrylic resin.

4. The colored laminate of claim 3, wherein the polyester comprises at least one material selected from the group consisting of polyethylene terephthalate (PET), polybutylene terephthalate (PBT), and copolymers thereof.

5. The colored laminate of claim 3, wherein the polyolefin comprises at least one material selected from the group consisting of polyethylene (PE), polypropylene (PP), polybutylene (PB), and copolymers thereof.

6. The colored laminate of claim 3, wherein the acrylic resin comprises at least one material selected from the group consisting of poly(methyl methacrylate) (PMMA), poly(methyl acrylate) (PMA), and copolymers thereof.

7. The colored laminate of claim 1, wherein:
the near-infrared-ray reflecting layer selectively reflects near-infrared-rays with a wavelength of 0.75 to 2.0 μm and has an average thickness of 1 to 150 nm; and
the long-wavelength infrared-ray radiating layer radiates a long-wavelength infrared-ray with a wavelength of 8 to 13 μm and has an average thickness of 10 to 300 μm.

8. The colored laminate of claim 1, wherein:
the visible light reflecting layer has an average thickness of 100 to 300 μm; and
the colored layer has an average thickness of 10 to 200 μm.

9. The colored laminate of claim 1, wherein the colored laminate an average emissivity of 50 to 98% for long-wavelength infrared-rays with a wavelength of 8 to 15 μm.

10. The colored laminate of claim 1, wherein the colored layer has a transmittance of 80% or greater for light with a wavelength of 400 to 780 nm and is colored with a chromatic color.

11. A radiative cooling material comprising:
a colored laminate for radiative cooling, the colored laminate comprising:
a near-infrared-ray reflecting layer comprising a metal;
a long-wavelength infrared-ray radiating layer disposed on the near-infrared-ray reflecting layer and comprising a first thermoplastic resin;
a visible light reflecting layer disposed on the long-wavelength infrared-ray radiating layer and comprising a second thermoplastic resin; and
a colored layer disposed on the visible light reflecting layer and comprising a third thermoplastic resin, wherein optical properties of the first thermoplastic resin, the second thermoplastic resin, and the third thermoplastic resin differ from each other.

12. The radiative cooling material of claim 11, wherein the radiative cooling material is applicable to an exterior material for a mobility or a building.

13. The radiative cooling material of claim 11, wherein the metal comprises at least one metal selected from the group consisting of aluminum, silver, gold, chromium, copper, platinum, iron, tin, nickel, and alloys thereof.

14. The radiative cooling material of claim 11, wherein:
the first thermoplastic resin comprises polyester;
the second thermoplastic resin comprises polyolefin; and
the third thermoplastic resin comprises acrylic resin.

15. The radiative cooling material of claim 14, wherein:
the polyester comprises at least one material selected from the group consisting of polyethylene terephthalate (PET), polybutylene terephthalate (PBT), and copolymers thereof;
the polyolefin comprises at least one material selected from the group consisting of polyethylene (PE), polypropylene (PP), polybutylene (PB), and copolymers thereof; and
the acrylic resin comprises at least one material selected from the group consisting of poly(methyl methacrylate) (PMMA), poly(methyl acrylate) (PMA), and copolymers thereof.

16. The radiative cooling material of claim 11, wherein:
the near-infrared-ray reflecting layer selectively reflects near-infrared-rays with a wavelength of 0.75 to 2.0 μm and has an average thickness of 1 to 150 nm;
the long-wavelength infrared-ray radiating layer radiates a long-wavelength infrared-ray with a wavelength of 8 to 13 μm and has an average thickness of 10 to 300 μm;
the visible light reflecting layer has an average thickness of 100 to 300 μm; and
the colored layer has an average thickness of 10 to 200 μm, has a transmittance of 80% or greater for light with a wavelength of 400 to 780 nm, and is colored with a chromatic color.

17. The radiative cooling material of claim 11, wherein the colored laminate an average emissivity of 50 to 98% for long-wavelength infrared-rays with a wavelength of 8 to 15 μm.

18. A mobility comprising:
a mobility body; and
a radiative cooling material disposed on an exterior surface of the mobility body, the radiative cooling material comprising a colored laminate for radiative cooling, the colored laminate comprising:
a near-infrared-ray reflecting layer comprising a metal;
a long-wavelength infrared-ray radiating layer disposed on the near-infrared-ray reflecting layer and comprising a first thermoplastic resin;
a visible light reflecting layer disposed on the long-wavelength infrared-ray radiating layer and comprising a second thermoplastic resin; and
a colored layer disposed on the visible light reflecting layer and comprising a third thermoplastic resin.

19. The mobility of claim 18, wherein:
the metal comprises at least one metal selected from the group consisting of aluminum, silver, gold, chromium, copper, platinum, iron, tin, nickel, and alloys thereof;
the first thermoplastic resin comprises polyester;
the second thermoplastic resin comprises polyolefin;
the third thermoplastic resin comprises acrylic resin;
the near-infrared-ray reflecting layer selectively reflects near-infrared-rays with a wavelength of 0.75 to 2.0 μm and has an average thickness of 1 to 150 nm;
the long-wavelength infrared-ray radiating layer radiates a long-wavelength infrared-ray with a wavelength of 8 to 13 μm and has an average thickness of 10 to 300 μm;
the visible light reflecting layer has an average thickness of 100 to 300 μm; and
the colored layer has an average thickness of 10 to 200 μm, has a transmittance of 80% or greater for light with a wavelength of 400 to 780 nm, and is colored with a chromatic color.

20. The mobility of claim 18, wherein the colored laminate an average emissivity of 50 to 98% for long-wavelength infrared-rays with a wavelength of 8 to 15 μm.
